(19) United States
(12) Patent Application Publication
(10) Pub. No.: US 2007/0298975 A1
(43) Pub. Date: Dec. 27, 2007

(54) DEVICE FOR DNA ANALYSIS AND DNA ANALYSIS APPARATUS

(75) Inventors: Mikio Ihama, Kanagawa (JP); Shinichi Watanabe, Kanagawa (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/766,328

(22) Filed: Jun. 21, 2007

(30) Foreign Application Priority Data
Jun. 26, 2006 (JP) P2006-175701

(51) Int. Cl. C40B 60/12

(52) U.S. Cl. 506/39

(57) ABSTRACT

A device for DNA analysis includes: an imaging device having a plurality of pixel parts; and microarrays arranged and fixed on a surface on a side of light incidence of the imaging device, wherein each of the plurality of pixel parts includes plural kinds of photoelectric conversion parts stacked on a semiconductor substrate and each capable of detecting light with a different wavelength region from each other to generate a charge corresponding thereto; the plural kinds of photoelectric conversion parts are stacked such that they are able to receive light from the same subject; and the plural kinds of photoelectric conversion parts are each configured of at least one photoelectric conversion device having sensitivity to the light to be detected in the photoelectric conversion part and arranged on a same plane.

### FIELD OF THE INVENTION

The present invention relates to a device for DNA analysis for performing DNA analysis.

### BACKGROUND OF THE INVENTION

In recent years, genetic information of an organism has been utilized in wide fields including a medical field and an agricultural field. In utilizing a gene, DNA analysis is indispensable. Here, DNA has two helically twisted polynucleotide chains; each of the polynucleotide chains has a nucleotide sequence in which four kinds of bases (adenine: A, guanine: G, cytosine: C, thymine: T) are one-dimensionally arranged; and the bases of one of the polynucleotide chains are bound to the bases of the other polynucleotide on the basis of complementarity between adenine and thymine and between guanine and cytosine.

Hitherto, for the purpose of performing DNA analysis, a microarray has been used. The microarray is used for the purpose of grasping qualitative and quantitative changes of a gene by utilizing a method called as hybridization. In general, hybridization is carried out on a microarray by using a fluorescence-labeled nucleic acid; its fluorescent intensity is detected by a scanner or a sensor such as a solid-state imaging device; and changes of a gene are judged from the fluorescent intensity. As another method other than the method of using hybridization, there is a method of using an intercalater by using a fluorescent compound which binds to only double chain DNA and emits light depending upon its amount.

According to the central dogma, a genetic code of an organism held by DNA is read and transmitted to RNA, whereby a protein is synthesized. The protein is a basic unit of an organism and becomes the root of its functional unit. DNA is a substance which is a vital point of genetic information, and a unit called as a base precisely forms a hydrogen bond of A-T or G-C, thereby forming a double helical structure. The term “hybridization” as referred to herein means a reaction in which double chain DNA causes reassociation. It is possible to perform sequence specific qualitative or quantitative analysis of DNA contained in a sample by utilizing this reaction.

Examples of the microarray include a microarray for expression analysis for measuring the amount of RNA, a microarray for detection of DNA single nucleotide polymorphisms (SNPs), a microarray for analysis of protein, and a microarray for detection of gene deletion or amplification in DNA called as CGH (comparative genomic hybridization). By microarraying, it is possible to specify not only a chromosome position of a fluctuating or varying gene but also a gene name. It is thought to apply it to analysis of function of a gene, judgment of a degree of progress of a cancer, selection of an effective drug prior to administration due to classification of a cancer, utilization of a drug design such as mutagenicity test, substitution of current karyotype analysis, diagnosis of a gene, search of a responsible gene to disease, analysis of a transcriptional gene, analysis of epigenetics, and the like.

The microarray is one in which a number of specific binding substances (hereinafter referred to as “DNA fragments”) which can be specifically bound to an organism-derived substance such as hormones, tumor markers, enzymes, antibodies, antigens, abzymes, other proteins, nucleic acids, cDNA, DNA, and RNA and which are known with respect to base sequence and length and composition of a base, and the like are arranged and fixed on a surface of a carrier such as a slide glass plate and a membrane filter. The DNA fragments are arranged on a flat plate in spots with a size of from 1 mm to 1 μm by pin spotting, photolithography, inkjetting, or the like. It is also possible to arrange 50,000 or more kinds of DNA fragments on a single flat plate. These DNA fragments can be obtained by, for example, selecting a unique sequence for specifically detecting a certain gene by utilizing a database and performing solid-phase synthesis on a flat plate by photolithography or after extracting a nucleic acid containing cDNA or genome DNA, performing PCR amplification.

Next, a method of performing DNA analysis by using a microarray is described.

First of all, a sample DNA which is an organism-derived substance collected from an organism, such as hormones, tumor markers, enzymes, antibodies, antigens, abzymes, other proteins, nucleic acids, cDNA, DNA, and mRNA by extraction, isolation or the like, or having been chemically treated or chemically modified or subjected to other treatment, and which is an organism-derived substance for a subject of the analysis (this sample DNA will be hereinafter referred to as “normal DNA”) is labeled by Cy3 (maximum excitation wavelength: about 532 nm, maximum fluorescent wavelength: about 570 nm) which is a fluorescent substance capable of emitting green (G) fluorescence; and a sample DNA which is a substance derived from an abnormal organism suffering from a cancer (this sample DNA will be hereinafter referred to as “specimen DNA”) is labeled by Cy5 (maximum excitation wavelength: about 635 nm, maximum fluorescent wavelength: about 670 nm) which is a fluorescent substance capable of emitting red (R) fluorescence.

Next, equal amounts of the normal DNA and the specimen DNA are mixed, and the mixture is subjected to hybridization, thereby binding each DNA fragment configuring the microarray to the sample DNA as a mixture of equal amounts. The microarray obtained by performing hybridization is irradiated with light capable of exciting Cy3, and fluorescence emitted from Cy3 is detected by a photodiode or the like. Next, the microarray is irradiated with light capable of exciting Cy5, and fluorescence emitted from Cy5 is detected by a photodiode or the like. As a light source for exciting Cy3 or Cy5, a green SHG solid-state laser or a red semiconductor laser is useful.

For example, as illustrated in FIG. 8, fluorescence emitted from a single DNA fragment M is detected by nine photodiodes (PD) on an upper surface of each of which is provided a color filter CF which transmits light having an R or G wavelength region therethrough. In the example of FIG. 8, five R signals corresponding to the R fluorescence and four G signals corresponding to the G fluorescence are detected. Then, for example, an average value of the five R signal is defined as a representative value of the R signal deterred from the DNA fragment M; and an average value of the four G signals is defined as a representative value of the G signal detected from the DNA fragment M.

Then, a fluorescent intensity is subjected to data analysis based on the representative values of fluorescent signals obtained from each of the DNA fragments and to clustering. With respect to fluorescence detected from a single DNA fragment, in comparison with the case where the normal DNA is normal, when a gene is amplified by a cancer, an R fluorescent intensity is strong, whereas when a gene is reduced or deficient by a cancer, a G fluorescent intensity is strong. By analyzing a ratio in intensity of the R fluorescence and the G fluorescence emitted from each of the DNA fragments, changes of RNA or genome DNA of the cancer are grasped, whereby it becomes possible to obtain information what gene has been changed. In this way, it is possible to support an adequate therapy.

According to this, in the DNA analysis using a microarray, a microarray, a light source for irradiating light on the microarray, a sensor for detecting fluorescence emitting from the microarray, and an optical system for converting the light outputted from the light source into parallel light and making it incident on the microarray are necessary. Since the microarray and the sensor for detecting fluorescence are separate from each other, the optical system must be designed in conformity with the configuration of each of the microarray and the sensor. In the case where it is intended to alter the sensor or in the case where it is intended to alter the microarray, the optical system must be replaced by a separate optical system each time. In this way, when the microarray and the sensor are separate from each other, the optical system becomes complicated, or the apparatus costs increase. However, in the DNA analysis using a microarray, a more simple, rapid and cheap system is required for a specified disease or examination.

Then, there has hitherto been proposed a device for DNA analysis in which microarrays are integrally provided on a surface of an imaging device having a number of photoelectric conversion devices arranged on the same plane, with an optical system being omitted (see JP-A-2004-205335).

### SUMMARY OF THE INVENTION

Since the device disclosed in JP-A-2004-205335 is able to detect only light of a single color of lights emitted from the microarrays, it cannot be applied to the foregoing DNA analysis using Cy3 and Cy5. For the application to DNA analysis using Cy3 and Cy5, as illustrated in FIG. 8, it is necessary to provide a color filter for transmitting light having an R wavelength region (light having a wavelength of from about 600 nm to about 660 nm; hereinafter referred to as “R light”) or light having a G wavelength region (light having a wavelength of from about 500 nm to about 560 nm; hereinafter referred to as “G light”) therethrough on an upper surface of a photodiode PD and make at least two photoelectric conversion devices capable of detecting the R light and the G light corresponding to a single DNA fragment.

However, in the case of employing the configuration as in FIG. 8, an area for receiving the R fluorescence and an area for receiving the G fluorescence emitted from the single DNA fragment become narrow so that detection sensitivity to the fluorescence cannot be made high. Since fluorescence emitted from a microarray is originally weak in its intensity and is hardly detectable, it is desired to make the detection sensitivity to the fluorescence high. Also, since the R fluorescence made incident on the G color filter is cut by this color filter, the intensity of the R fluorescence made incident on this portion cannot be taken into consideration, and the detection precision is lowered. Similarly, since the G fluorescence made incident on the R color filter is cut by this color filter, the intensity of the G fluorescence made incident on this portion cannot be taken into consideration, and the detection precision is lowered.

Under the foregoing circumstances, the invention has been made, and its object is to provide a device for DNA analysis capable of improving an analytical ability in DNA analysis using a microarray.

(1) A device for DNA analysis for performing DNA analysis comprising an imaging device having a number of pixel parts arranged on the same plane; and microarrays arranged and fixed on a surface on a side of light incidence of the imaging device, wherein each of the number of pixel parts contains plural kinds of photoelectric conversion parts stacked on a semiconductor substrate and each capable of detecting light with a different wavelength region from each other to generate a charge corresponding thereto; the plural kinds of photoelectric conversion parts are stacked such that they are able to receive light from the same subject; and the plural kinds of photoelectric conversion parts are each configured of at least one photoelectric conversion device having sensitivity to the light to be detected in the photoelectric conversion part and arranged on the same plane.

### (2) The device for DNA analysis as set forth in (1), wherein each of a number of DNA fragments configuring the microarrays and each of the number of pixel parts are corresponding one-to-one with each other.

### (3) The device for DNA analysis as set forth in (1) or (2), wherein the plural kinds of photoelectric conversion parts are each configured of a single photoelectric conversion device.

(4) The device for DNA analysis as set forth in any one of (1) to (3), wherein the plural kinds of photoelectric conversion parts contained in the pixel part contain at least one organic photoelectric conversion part which is configured of an organic photoelectric conversion device containing a pair of electrodes and an organic photoelectric conversion layer interposed between the pair of electrodes and at least one inorganic photoelectric conversion part which is configured of an inorganic photoelectric conversion device formed within the semiconductor substrate.
(5) The device for DNA analysis as set forth in (4), wherein the imaging device is provided with a passivation layer for passivating the organic photoelectric conversion device which is formed in an upper part of the organic photoelectric conversion device by an ALCVD method.

### (6) The device for DNA analysis as set forth in (5), wherein the passivation layer is made of an inorganic material.

### (7) The device for DNA analysis as set forth in (5), wherein the passivation layer is of a two-layer structure composed of an inorganic layer made of an inorganic material and an organic layer made of an organic polymer.

### (8) The device for DNA analysis as set forth in any one of (4) to (7), wherein the plural kinds of photoelectric conversion parts are two of the organic photoelectric conversion part and the inorganic photoelectric conversion part.

(9) The device for DNA analysis as set forth in (8), wherein the organic photoelectric conversion device has sensitivity to light of a red or green wavelength region; and the inorganic photoelectric conversion device has sensitivity to light of a green or red wavelength region.
(10) The device for DNA analysis as set forth in (9), wherein the organic photoelectric conversion device has sensitivity to light of a green wavelength region; and the inorganic photoelectric conversion device has sensitivity to light of a red wavelength region.
(11) The device for DNA analysis as set forth in any one of (1) to (7), wherein at the DNA analysis, each of the number of DNA fragments configuring the microarrays is bound with plural sample DNAs labeled by each of plural kinds of fluorescent substances each of which is excited by excitation light to emit fluorescence of a wavelength region detectable by each of the plural kinds of photoelectric conversion parts; and an excitation light incidence preventing unit for preventing the excitation light for exciting each of the plural kinds of fluorescent substances from incidence into the photoelectric conversion part which is able to detect the fluorescence emitted from the fluorescent substance is provided.
(12) The device for DNA analysis as set forth in any one of (8) to (10), wherein at the DNA analysis, each of the number of DNA fragments configuring the microarrays is bound with two sample DNAs labeled by each of two fluorescent substances each of which is excited by excitation light to emit fluorescence of a wavelength region detectable by each of the organic photoelectric conversion part and the inorganic photoelectric conversion part; and an excitation light incidence preventing unit for preventing the excitation light for exciting each of the two fluorescent substances from incidence into the photoelectric conversion part which is able to detect the fluorescence emitted from the fluorescent substance is provided.
(13) The device for DNA analysis as set forth in (12) wherein the excitation light incidence preventing unit is configured of a first excitation light cut-off filter and a second excitation light cut-off filter; the first excitation light cut-off filter is provided between the inorganic photoelectric conversion part and the organic photoelectric conversion part and prevents transmission of the excitation light for exciting the fluorescent substance which emits fluorescence of a wavelength region detectable by the inorganic photoelectric conversion part; and the second excitation light cut-off filter is provided in an upper part of the organic photoelectric conversion part and prevents transmission of the excitation light for exciting the fluorescent substance which emits fluorescence of a wavelength region detectable by the organic photoelectric conversion part.
(14) The device for DNA analysis as set forth in any one of (1) to (13), wherein a signal readout part for reading out a signal corresponding to the charge generated in each of the plural kinds of photoelectric conversion parts by CCD or a CMOS circuit is provided.

### (15) The device for DNA analysis as set forth in (14), wherein the signal readout part reads out the signal by a CMOS circuit; and a part of the CMOS circuit is made common in the plural kinds of photoelectric conversion parts.

### (16) The device for DNA analysis as set forth in any one of (1) to (15), wherein the microarrays are a microarray for performing DNA analysis by hybridization.

### (17) A DNA analysis apparatus comprising the device for DNA analysis as set forth in any one of (1) to (16); and a light outputting unit for outputting light obliquely against the surface of the imaging device having the microarrays formed therein.

According to the invention, it is possible to provide a device for DNA analysis capable of improving an analytical ability in DNA analysis using a microarray.

### BRIEF DESCRIPTION OF THE DRAWINGS

FIG. 1 is a view to show an outline configuration of a DNA analysis system using a microarray for the purpose of explaining an embodiment of the invention.

FIG. 2 is a schematic view of a surface of the device for DNA analysis as illustrated in FIG. 1.

FIG. 3 is a cross-sectional schematic view of an X-X line as illustrated in FIG. 2.

FIG. 4 is a view to show a specific configuration example of a signal readout part as illustrated in FIG. 3.

FIGS. 5A, 5B and 5C are each a schematic view to explain a modification example of a device for DNA analysis.

FIGS. 6A, 6B and 6C are each a schematic view to explain a modification example of a device for DNA analysis.

FIG. 7 is a cross-sectional schematic view to explain a modification example of a device for DNA analysis.

FIG. 8 is a view to explain a related-art DNA analysis method.

### DESCRIPTION OF REFERENCE NUMERALS AND SIGNS

1: Device for DNA analysis
2: Light source
3: DNA analysis apparatus
4: Board
5: n-Type silicon substrate
100: Imaging device
100a: Pixel part
200: DNA fragment
6: p-Well layer
7: n-Type impurities region
8: Signal readout part
9: Gate insulating layer
10, 12, 17: Insulating layer
11: R excitation light cut-off filter
13: Pixel electrode
14: Organic photoelectric conversion layer
15: Counter electrode
16, 19: Passivation layer
18: G excitation light cut-off filter
20, 21, 24: Wiring
22: Electrode pad
23: Molding resin
25: Terminal

### DETAILED DESCRIPTION OF THE INVENTION

Embodiments of the invention are hereunder described with reference to the accompanying drawings.

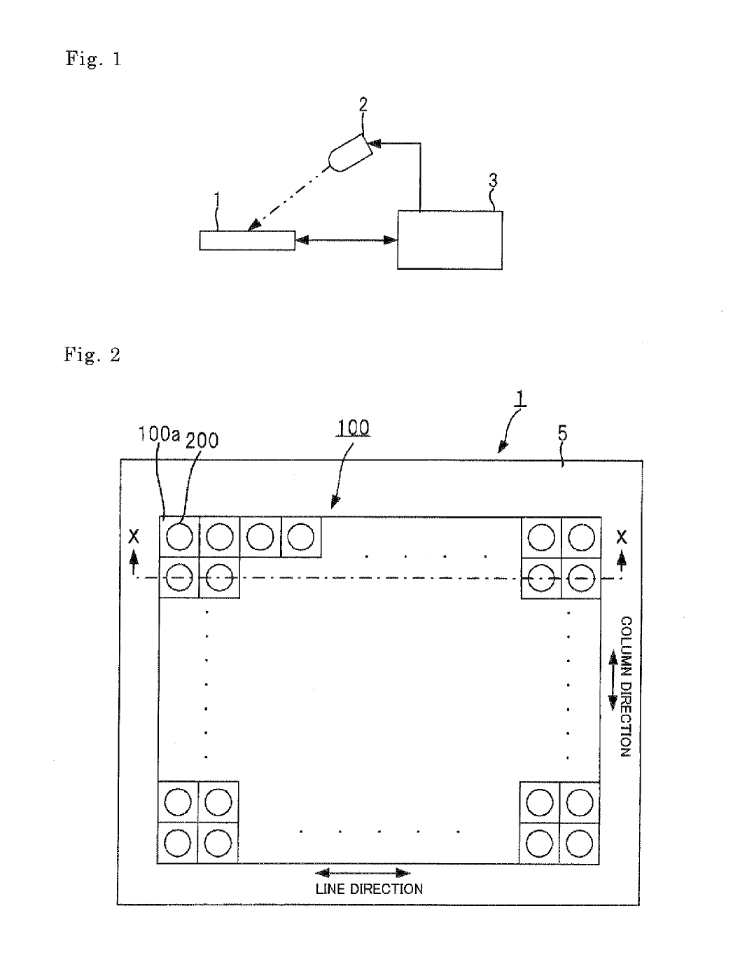

FIG. 1 is a view to show an outline configuration of a DNA analysis system using a microarray for the purpose of explaining an embodiment of the invention. A DNA fragment configuring a microarray as explained in the present embodiment is a DNA fragment in which a mixture of equal amounts of a normal DNA labeled by Cy3 and a specimen DNA labeled by Cy5 is bound by hybridization at the DNA analysis. In order to detect a specified gene, as the DNA fragment configuring a microarray, an oligo sequence composed of approximately 50 molecules selected from a human gene database or the like is used. Though the number of DNA fragments varies with the quantity of information of a gene to be analyzed, from approximately 100 to approximately 1,000,000 DAN fragments are often used.

The DNA analysis system as illustrated in FIG. 1 includes a device 1 for DNA analysis in which an imaging device and a microarray are integrated; a light source 2 functioning as a light irradiation unit for irradiating light on the device 1 for DNA analysis; and a DNA analysis apparatus 3 for not only controlling the actions of the light source 2 and the device 1 for DNA analysis but also performing DNA analysis based on a signal obtained from the device 1 for DNA analysis.

The light source 2 has a green SHG laser capable of outputting excitation light of about 532 nm which is a maximum excitation wavelength of Cy3 and a red semiconductor laser capable of outputting excitation light of about 635 nm which is a maximum excitation wavelength of Cy5 built-in therein and starts up one of the foregoing lasers due to the control from the DNA analysis apparatus 3, thereby outputting excitation light. A non-illustrated collimator lens is provided in front of the light outputting surface of the light source 2, and the outputted light is converted into parallel light and made incident on a surface of the device 1 for DNA analysis. The light source 2 is disposed such that the excitation light is made incident from an oblique direction against the surface of the device 1 for DNA analysis.

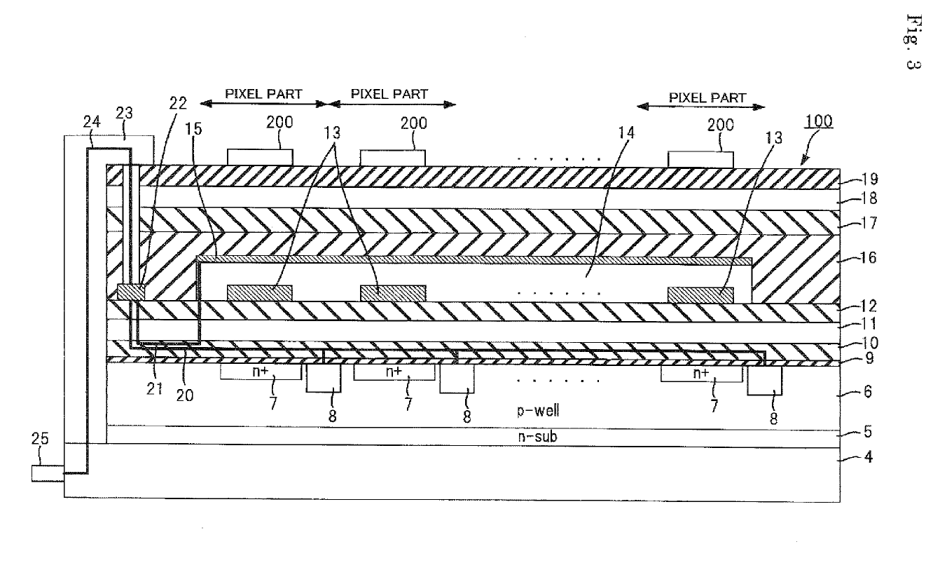

FIG. 2 is a schematic view of the surface of the device 1 for DNA analysis as illustrated in FIG. 1. FIG. 3 is a cross-sectional schematic view of an X-X line as illustrated in FIG. 2.

The device 1 for DNA analysis includes a microarray composed of an imaging device 100 including a number of pixel parts 100a arranged in a column direction orthogonal to a line direction on an n-type silicon substrate 5 as a semiconductor substrate and a number of DNA fragments 200 arranged and fixed to a surface of the imaging device 100 on a side of light incidence. Each of the DNA fragments 200 configuring the microarray and each of the number of the pixel parts 100a are corresponding one-to-one with each other.

The pixel part 100a includes an inorganic photoelectric conversion part configured of an inorganic photoelectric conversion device capable of detecting R light to generate a charge corresponding thereto (having sensitivity to R light) and an organic photoelectric conversion part configured of an organic photoelectric conversion device capable of detecting G light to generate a charge corresponding thereto (having sensitivity to G light), with the organic photoelectric conversion part and the inorganic photoelectric conversion part being stacked on the n-type silicon substrate 5.

As illustrated in FIG. 3, the n-type silicon substrate 5 is formed on a board 4 provided with a terminal 25; and a p-well layer 6 is formed thereon. An n-type impurities region 7 (hereinafter referred to as “n-region 7”) is formed in a surface part of the p-well layer 6 in each of the number of pixel parts 100a; and a photodiode A as an inorganic photoelectric conversion device is configured by means of pn junction between the p-well layer 6 and the n-region 7. A depth of the n-region 7 is designed such that this photodiode A has sensitivity to R light. This single photodiode A configures the inorganic photoelectric conversion part contained in the pixel part 100a.

A gate insulating layer 9 is formed on the p-well layer 6; and an insulating layer 10 made of silicon oxide, etc. which is transparent to incident light is formed thereon. An R excitation light cut-off filter 11 capable of preventing transmission of light having a maximum excitation wavelength of Cy5 and transmitting light having a maximum fluorescent wavelength of Cy5 therethrough is formed on the insulating layer 10. As a material of the R excitation light cut-off filter 11, for example, a dispersion of a pigment based or dye based material in a methacrylate based binder is preferably used. Quinophthalone based, pyridone azo based and phthalocyanine based materials can be preferably used. With respect to characteristics of the R excitation light cut-off filter 11, a transmittance of the light having a maximum fluorescent wavelength of Cy5 is preferably 1,000 times or more, more preferably 10,000 times or more, and further preferably 100,000 times or more of a transmittance of the light having a maximum excitation wavelength of Cy5.

An insulating layer 12 made of silicon oxide, etc. which is transparent to incident light is formed on the R excitation light cut-off filter 11. Pixel electrodes 13 made of ITO, etc. which are separated for every pixel part 100a and which are transparent to incident light are formed on the insulating layer 12 in an upper part of the n-region 7; and a photoelectric conversion layer 14 made of an organic material is formed on the pixel electrodes 13. A counter electrode 15 made of ITO, etc. which is configured of a common single sheet to all the pixel parts 100a and which is transparent to incident light is formed on the photoelectric conversion layer 14; and a passivation layer 16 made of a transparent insulating material, etc. which is transparent to incident light is formed on the counter electrode 15.

An organic photoelectric conversion device (hereinafter referred to as “organic photoelectric conversion device B”) is configured to include the pixel electrodes 13, the counter electrode 15 and the photoelectric conversion layer 14 interposed between these electrodes. This single organic photoelectric conversion device B configures the organic photoelectric conversion part contained in the pixel part 100a. As the photoelectric conversion layer 14, a material having sensitivity to G light can be used, and examples of the material having such a characteristic include quinacridone.

Though the device 1 for DNA analysis is heated during the hybridization, the organic photoelectric conversion layer 14 is weak against a heat. For that reason, there is a possibility that the characteristics of the organic photoelectric conversion device B are deteriorated due to the hybridization so that the fluorescence cannot be precisely detected. The passivation layer 16 is provided for the purpose of preventing such affairs from occurring. It is preferable that the passivation layer 16 is an inorganic layer made of an inorganic material as formed by an ALCVD method. The ALCVD method is an atomic layer CVD method and is able to form a minute inorganic layer; and the passivation layer 16 can be an effective passivation layer of the organic photoelectric conversion device B. The ALCVD method is also known as an ALE method or an ALD method. The inorganic layer formed by the ALCVD method is preferably made of Al₂O₃, SiO₂, TiO₂, ZrO₂, MgO, HfO₂ or Ta₂O₅, more preferably made of Al₂O₃ or SiO₂, and most preferably made of Al₂O₃.

Also, for the purpose of more improving the passivation performance of the organic photoelectric conversion device B, it is preferable that the passivation layer 16 is of a two-layer structure of the foregoing inorganic layer and an organic layer made of an organic polymer. As the organic polymer, parylenes are preferable, and parylene C is more preferable. In that case, a high passivation effect is obtainable especially in the case where the inorganic layer and the organic layer are stacked in this order.

An insulating layer 17 made of silicon oxide, etc. which is transparent to incident light is formed on the passivation layer 16. A G excitation light cut-off filter 18 capable of preventing transmission of light having a maximum excitation wavelength of Cy3 and transmitting light having a maximum fluorescent wavelength of Cy3 therethrough is formed on the insulating layer 17. As a material of the G excitation light cut-off filter 18, for example, a dispersion of a pigment based or dye based material in a methacrylate based binder is preferably used. Pyrazolotriazole based, azaphthalocyanine based and phthalocyanine based materials can be preferably used. With respect to characteristics of the G excitation light cut-off filter 18, a transmittance of the light having a maximum fluorescent wavelength of Cy3 is preferably 1,000 times or more, more preferably 10,000 times or more, and further preferably 100,000 times or more of a transmittance of the light having a maximum excitation wavelength of Cy3.

A passivation layer 19 which is transparent to incident light is formed on the G excitation light cut-off filter 18. A DNA fragment 200 corresponding to the pixel part 100a is formed on the passivation layer 19 in an upper part of the n-region 7. The DNA fragment 200 can be formed by pin spotting, inkjetting, photolithography, or the like.

The passivation layer 19 may be a layer containing silicon oxide or silicon nitride as a major component or other organic polymer layer. It is preferable that the passivation layer 19 is subjected to an appropriate priming treatment for the purpose of improving the bonding or adhesion to the microarray. Also, an antireflection treatment may be applied by superimposing a dielectric layer thereon for the purpose of introducing fluorescence from the microarray into the organic photoelectric conversion device B or the photodiode A with good efficiency.

The photodiode A and the organic photoelectric conversion device B contained in the pixel part 100a are each determined with respect to the position and size (aperture) such that fluorescence emitted from the DNA fragment 200 corresponding to the pixel part 100a can be detected at the same position. A size of each of the DNA fragments 200, a distance between the respective DNA fragments 200 and a distance from each of the DNA fragments 200 to the photodiode A (synonymous with the distance to the surface of the n-region 7) are properly adjusted such that fluorescence emitted from the DNA fragment 200 corresponding to a certain pixel part 100a is not detected by the photodiode A or the organic photoelectric conversion device B within an adjacent pixel part 100a. It is preferable that the distance between the respective DNA fragments 200 is 10 μm and that the distance from each of the DNA fragments 200 to the photodiode A is not more than 10 μm.

A signal readout part 8 which is provided corresponding to the pixel part 100a and which reads out a signal corresponding to a charge generated in each of the inorganic photoelectric conversion part and the organic photoelectric conversion part contained in the pixel part 100a is formed within the p-well layer 6.

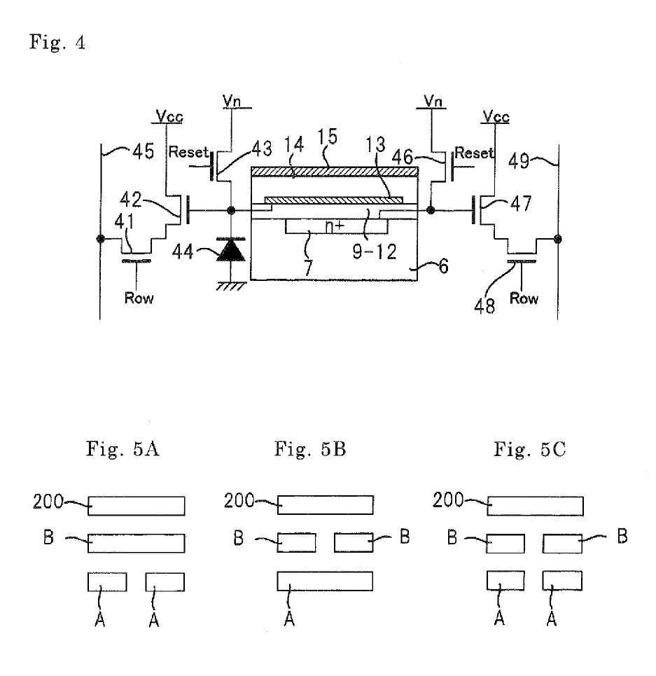

FIG. 4 is a view to show a specific configuration example of the signal readout part 8 as illustrated in FIG. 3. In FIG. 4, the same symbols are given to the same configurations as in FIG. 3.

The signal readout part 8 is configured of the n-type impurities region 7 formed within the p-well layer 6. The signal readout part 8 includes a storage diode 44 for storing a charge generated in the photoelectric conversion layer 14; a reset transistor 43 in which a drain thereof is connected to the storage diode 44 and a source thereof is connected to a power source Vn; an output transistor 42 in which a gate thereof is connected to the drain of the reset transistor 43 and a source thereof is connected to a power source Vcc; a line selection transistor 41 in which a source thereof is connected to a drain of the output transistor 42 and a drain thereof is connected to a signal output line 45; a reset transistor 46 in which a drain thereof is connected to the n-region 7 and a source thereof is connected to a power source Vn; an output transistor 47 in which a gate thereof is connected to the drain of the reset transistor 46 and a source thereof is connected to a power source Vcc; and a line selection transistor 48 in which a source thereof is connected to the drain of the output transistor 47 and a drain thereof is connected to a signal output line 49.

The storage diode 44 is electrically connected to the pixel electrode 13 by the gate insulating layer 9, the insulating layer 10, the R excitation light cut-off filter 11, and a contact part (not illustrated) buried in the insulating layer 12 and made of a metal such as aluminum.

By applying a bias voltage between the pixel electrode 13 and the counter electrode 15, a charge generated in the photoelectric conversion layer 14 is transferred into the storage diode 44 via the pixel electrode 13. The charge stored in the storage diode 44 is converted into a signal corresponding to the quantity of a charge in the output transistor 42. Then, by turning on the line selection transistor 41, the signal is outputted into the signal output line 45. After outputting a signal, the charge within the storage diode 44 is reset by the reset transistor 43.

The charge generated and stored in the n-region 7 is converted into a signal corresponding to the quantity of a charge in the output transistor 47. Then, by turning on the line selection transistor 48, the signal is outputted into the signal output line 49. After outputting a signal, the charge within the n-region 7 is reset by the reset transistor 46.

In this way, the signal readout part 8 can be configured of a known CMOS circuit composed of three transistors. Incidentally, it is possible to make the MOS circuit (the transistors 46, 47 and 48) for reading out a signal corresponding to the charge stored in the n-region 7 serve as an MOS circuit (the transistors 41, 42 and 43) for reading out a signal corresponding to the charge stored in the storage diode 44 at the same time. According to this, the circuit area can be reduced. For example, there may be employed a configuration in which the source of the MOS transistor is connected to each of the storage diode 44 and the n-region 7 and the drain of this MOS transistor is connected to the gate of the output transistor 42. Then, by controlling a gate voltage of the MOS transistor connected to each of the storage diode 44 and the n-region 7 and selecting which signal of the storage diode 44 or the n-region 7 should be read out, the signal may be read out in the selected order via the transistors 41, 42 and 43.

Incidentally, the signal readout part 8 can be configured of CCD, too. In that case, the charge stored in each of the storage diode 44 and the n-region 7 may be read out and transferred in a charge transfer channel formed within the p-well layer 6 and finally converted into a signal and outputted.

An electrode pad 22 is formed in a region where the photoelectric conversion layer 14 on the insulating layer 12 is not formed; and this electrode pad 22 is connected to the counter electrode 15 and each of the signal readout parts 8 by wirings 20 and 21. An aperture is formed in the passivation layer 16, the insulating layer 17, the G excitation light cut-off filter 18 and the passivation layer 19 on the electrode pad 22; and the terminal 25 provided in the board 4 and the electrode pad 22 are connected to each other via this aperture by a wiring 24. The wiring 24 is covered by a molding resin 23.

A bias voltage to be applied to the counter electrode 15, a drive signal for driving the signal readout part 8, and the like can be supplied via the wiring 24 and the wirings 20 and 21. Also, a signal read out from the signal readout part 8 is outputted from the terminal 25 via the wiring 24 and the wiring 20.

In the device 1 for DNA analysis, the organic photoelectric conversion device B, the photodiode A and the signal readout part 8 are properly designed such that detection sensitivity of the organic photoelectric conversion device B and detection sensitivity of the photodiode A become equal to each other. The “detection sensitivity” as referred to herein means a ratio of a prescribed quantity of light to be made incident on a photoelectric conversion device and a quantity of a signal to be outputted externally from the photoelectric conversion device.

Next, a method of performing the DNA analysis using the thus configured DNA analysis apparatus is described.

First of all, in order to make the DNA fragment 200 of the microarray have a single chain, the device 1 for DNA analysis is treated with hot water and then dried. Next, a normal DNA obtained from a specimen is labeled by Cy3, and a specimen DNA is labeled by Cy5. Next, the normal DNA and the specimen DNA are mixed in equal amounts; the sample DNA obtained by mixing is added dropwise to each of the DNA fragments 200, thereby performing hybridization to bind each of the DNA fragments 200 configuring the microarray to the sample DNA as a mixture of equal amounts. In these treatments, though the device 1 for DNA analysis is exposed to water or a heat, the deterioration in performance of the organic photoelectric conversion device B is suppressed due to the function of the passivation layer 16 and the passivation layer 19.

Next, each of the DNA fragments 200 obtained by performing the hybridization is irradiated with light capable of exciting Cy5 from the light source 2; and R fluorescence emitted from the DNA fragment 200 is detected by the photodiode A within the pixel part 100a corresponding to the subject DNA fragment 200. Next, each of the DNA fragments 200 obtained by performing the hybridization is irradiated with light capable of exciting Cy3 from the light source 2; and G fluorescence emitted from the DNA fragment 200 is detected by the organic photoelectric conversion device B within the pixel part 100a corresponding to the subject DNA fragment 200.

The charge generated in each of the organic photoelectric conversion device B and the photodiode A within the pixel part 100a is converted into a signal by the signal readout part 8 and outputted from the device 1 for DNA analysis. Then, when the DNA analysis apparatus 3 analyzes a ratio in intensity of the R fluorescence and the G fluorescence emitted from each of the DNA fragments 200, changes of RNA or genome DNA of the cancer are grasped, whereby it becomes possible to obtain information what gene has been changed.

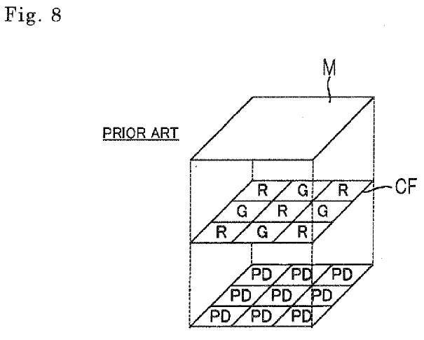

In this way, according to the device 1 for DNA analysis, the R fluorescence and the G fluorescence emitted from the single DNA fragment 200 can be detected at the same position by the stacked organic photoelectric conversion device B and photodiode A. For that reason, in comparison with the related-art configuration as illustrated in FIG. 8 in which the R fluorescence and the G fluorescence emitted from the single DNA fragment 200 must be detected by at least two photoelectric conversion devices arranged on the same plane, an aperture of the organic photoelectric conversion device B and the photodiode A can be made large, and the detection sensitivity of the fluorescence can be improved.

Also, since the R fluorescence and the G fluorescence emitted from the single DNA fragment 200 can be detected at the same position, the problem as in the related-art configuration as illustrated in FIG. 8 that the information of the R fluorescence which has been made incident on the photoelectric conversion device for detecting the G fluorescence and the information of the G fluorescence which has been made incident on the photoelectric conversion device for detecting the R fluorescence cannot be taken into consideration can be avoided, and the detection precision of fluorescence can be improved.

Also, according to the device 1 for DNA analysis, by providing the G excitation light cut-off filter 18 and the R excitation light cut-off filter 11, it is possible to prevent a phenomenon in which the organic photoelectric conversion device B and the photodiode A detect the excitation light of Cy3 and the excitation light of Cy5 from occurring, and the detection precision of fluorescence can be improved. Even in the related-art configuration as illustrated in FIG. 8, by controlling such that excitation light for exciting Cy5 is not made incident on each PD in a lower part of CF of R and that excitation light for exciting Cy3 is not made incident on each PD in a lower part of CF of G, the detection precision can be improved. However, in the case of the configuration as illustrated in FIG. 8, it is necessary to set up a filter satisfied with requirements that it not only cuts off the maximum excitation wavelength of Cy3 and transmits the maximum fluorescence wavelength of Cy3 but also cuts off the maximum excitation wavelength of Cy5 and transmits the maximum fluorescence wavelength of Cy5 between each PD and the microarray.

Such a filter involves problems that the material selection and design and the like are difficult and that the costs are high. In contrast, in the device 1 for DNA analysis, since it is only required that the R excitation light cut-off filter 11 and the G excitation light cut-off filter 18 are formed over the entire surface of the silicon substrate 5, the manufacture can be easily carried out, and the manufacturing costs can be reduced.

Also, according to the device 1 for DNA analysis, since the passivation layer 16 is provided, even in the case of performing a hot water treatment for making the DNA fragment 200 have a single chain or a heating treatment at the hybridization, the deterioration in characteristics of the organic photoelectric conversion device B can be prevented, and the reliability can be enhanced.

While the device 1 for DNA analysis has been described, it is possible to add various modifications in the foregoing configurations in the device 1 for DNA analysis.

For example, the inorganic photoelectric conversion part contained in the pixel part 100a may be configured of a plurality of photodiodes A arranged on the same plane. An example of FIG. 5A is an example in which two photodiodes A and an organic photoelectric conversion device B stacked in an upper part of the two photodiodes A are made corresponding to a single DNA fragment 200. According to this configuration, G fluorescence emitted from the DNA fragment 200 can be detected by the organic photoelectric conversion device B; and R fluorescence can be detected by the two photodiodes A. In the case of this configuration, for example, by setting up the detection sensitivity of the photodiode A as a half of the organic photoelectric conversion device B and adding two signals obtained from the two photodiodes A to make a signal corresponding to the R fluorescence, a ratio in intensity of the R fluorescence and the G fluorescence may be determined from this signal along with a signal corresponding to the G fluorescence obtained from the organic photoelectric conversion device B.

Also, the organic photoelectric conversion part contained in the pixel part 100a may be configured of a plurality of organic photoelectric conversion devices B arranged on the same plane. An example of FIG. 5B is an example in which a single photodiode A and two organic photoelectric conversion devices B stacked in an upper part of the single photodiode A are made corresponding to a single DNA fragment 200. According to this configuration, G fluorescence emitted from the DNA fragment 200 can be detected by the two organic photoelectric conversion devices B; and R fluorescence can be detected by the single photodiode A. In the case of this configuration, for example, by setting up the detection sensitivity of the organic photoelectric conversion device B as a half of the photodiode A and adding two signals obtained from the two organic photoelectric conversion devices B to make a signal corresponding to the G fluorescence, a ratio in intensity of the R fluorescence and the G fluorescence may be determined from this signal along with a signal corresponding to the R fluorescence obtained from the photodiode A.

Also, the inorganic photoelectric conversion part contained in the pixel part 100a may be configured of a plurality of photodiodes A arranged on the same plane, and the organic photoelectric conversion part contained in the pixel part 100a may be configured of a plurality of organic photoelectric devices B arranged on the same plane. An example of FIG. 5C is an example in which two photodiodes A and two organic photoelectric conversion devices B stacked in an upper part of the two photodiodes A are made corresponding to a single DNA fragment 200. According to this configuration, G fluorescence emitted from the DNA fragment 200 can be detected by the two organic photoelectric conversion devices B; and R fluorescence can be detected by the two photodiodes A. In the case of this configuration, for example, by adding two signals obtained from the two organic photoelectric conversion devices B to make a signal corresponding to the G fluorescence and adding two signals obtained by the two photodiodes A to make a signal corresponding to the R fluorescence, a ratio in intensity of the R fluorescence and the G fluorescence may be determined.

Also, the photoelectric conversion part contained in the pixel part 100a may be composed of only an organic photoelectric conversion part and configured of a stack of two or more layers thereof; the photoelectric conversion part contained in the pixel par 100a may be composed of only an inorganic photoelectric conversion part and configured of a stack of two or more layers thereof; and the photoelectric conversion part contained in the pixel part 100a may be composed of an organic photoelectric conversion part and an inorganic photoelectric conversion part and configured of a stack of three or more parts thereof in combination. Incidentally, in the case where the photoelectric conversion part contained in the pixel part 100a is composed of three or more parts, it is preferable that a filter capable of preventing transmission of a maximum excitation wavelength of a fluorescent substance capable of emitting fluorescence of a wavelength region to be detected in each of the photoelectric conversion parts and transmitting a maximum fluorescent wavelength of the subject fluorescent substance in an upper part of each photoelectric conversion part.

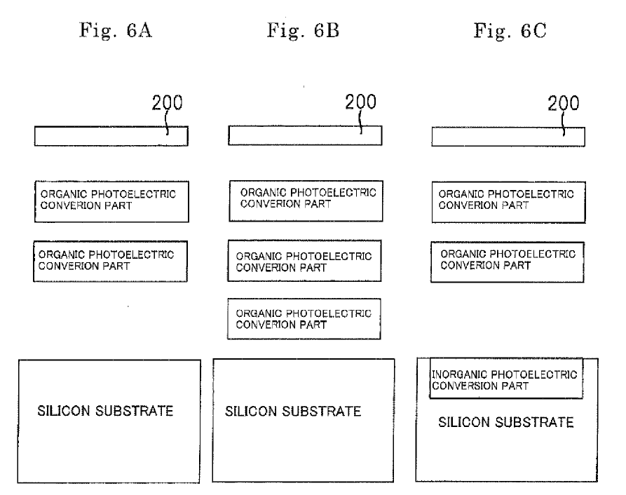

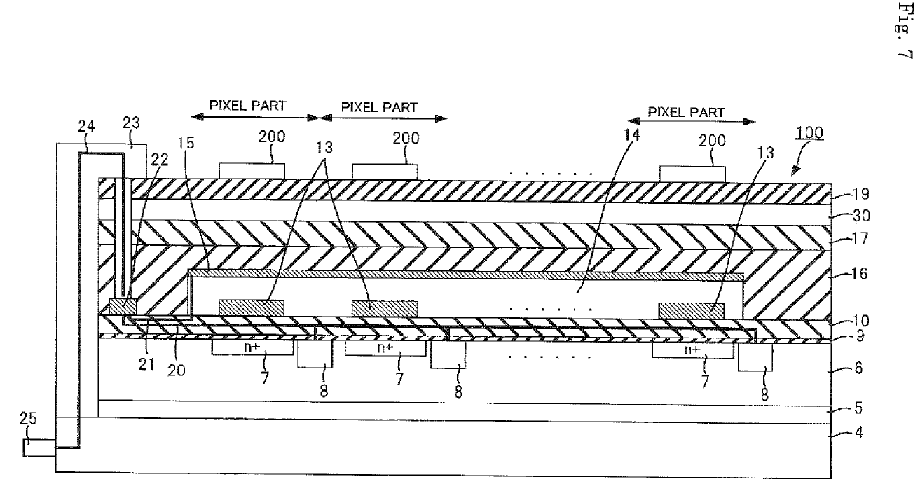

FIG. 6A shows an example in which two organic photoelectric conversion parts configured of a single organic photoelectric conversion device B are stacked and these parts are made corresponding to a single DNA fragment 200. In the case of this configuration, one of the two organic photoelectric conversion devices B may be made to have sensitivity to G light, with the other being made to have sensitivity to R light.

FIG. 6B shows an example in which three organic photoelectric conversion parts configured of a single organic photoelectric conversion device B are stacked and these parts are made corresponding to a single DNA fragment 200. In the case of this configuration, the three organic photoelectric conversion devices B may be made to have a different wavelength region of light to be detected from each other. According to this configuration, it is possible to increase the number of sample DNAs to be bound to the DNA fragment 200.

An example of FIG. 6C is an example in which two organic photoelectric conversion parts configured of a single organic photoelectric conversion device B are stacked in an upper part of an inorganic photoelectric conversion part configured of a single photodiode A and the inorganic photoelectric conversion part and the two organic photoelectric conversion parts are made corresponding to a single DNA fragment 200. In the case of this configuration, the two organic photoelectric conversion devices B and the photodiode A may be made to have a different wavelength region to be detected from each other. According to this configuration, it is possible to increase the number of sample DNAs to be bound to the DNA fragment 200.

Also, though in the example of FIG. 3, the G light is detected by the organic photoelectric conversion device B and the R light is detected by the photodiode A, there may be employed a configuration that the R light is detected by the organic photoelectric conversion device B, with the G light being detected by the photodiode A. In that case, the positions of the G excitation light cut-off filter 18 and the R excitation light cut-off filter 11 may be reversed to each other.

Also, though in the example of FIG. 1, the light is outputted obliquely from the light source 2 toward the device 1 for DNA analysis, it should not be construed that the invention is limited thereto; and the light may be made incident from a vertical direction to the surface of the device 1 for DNA analysis. As illustrated in FIG. 3, since the device 1 for DNA analysis is provided with the G excitation light cut-off filter 18 and the R excitation light cut-off filter 11, the excitation light is not substantially made incident on the photoelectric conversion layer 14 or the n-region 7, but a possibility of incidence of the excitation light still remains a little. Then, as illustrated in FIG. 1, by making the light incident obliquely from the light source 2, it is possible to more reduce this possibility and to more improve the detection precision.

Also, in the example of FIG. 3, though the excitation light cut-off filters are provided, when a time is required to some extent until the fluorescent substance emits fluorescence after incidence of the excitation light, the excitation light cut-off filter can be omitted.

Also, in the example of FIG. 3, the detection precision is improved by providing the R excitation light cut-off filter 11 in an upper part of the photodiode A and providing the G excitation light cut-off filter 18 in an upper part of the organic photoelectric conversion device B. But, by using an R and G excitation light cut-off filter which is satisfied with the requirements that it not only cuts off the maximum excitation wavelength of Cy3 and transmits the maximum fluorescence wavelength of Cy3 but also cuts off the maximum excitation wavelength of Cy5 and transmits the maximum fluorescence wavelength of Cy5, it is also possible to improve the detection precision. In that case, as illustrated in FIG. 7, there may be employed a configuration that an R and G excitation light cut-off filter 30 is provided between the insulating layer 17 and the passivation layer 19.

Each of the G excitation light cut-off filter 18 and the R excitation light cut-off filter 11 and the R and G excitation light cut-off filter 30 functions as an excitation light incidence preventing unit as recited in the appended claims.

Finally, a specific configuration example of the organic photoelectric conversion device B is described.

### (Explanation of Organic Photoelectric Conversion Layer (Organic Layer))

The organic layer is formed by stacking or mixing a photoelectric conversion site, an electron transport site, a hole transport site, an electron blocking site, a hole blocking site, a crystallization preventing site, a layer-to-layer contact improving site, and the like. It is preferable that the organic layer contains an organic p-type compound or an organic n-type compound. The organic p-type semiconductor (compound) is an organic semiconductor (compound) having donor properties and refers to an organic compound which is mainly represented by a hole transporting organic compound and which has properties such that it is liable to donate an electron. In more detail, the organic p-type semiconductor refers to an organic compound having a smaller ionization potential in two organic compounds when they are brought into contact with each other and used. Accordingly, with respect to the organic compound having donor properties, any organic compound can be used so far as it is an electron donating organic compound. Useful examples thereof include triarylamine compounds, benzidine compounds, pyrazoline compounds, styrylamine compounds, hydrazone compounds, triphenylmethane compounds, carbazole compounds, polysilane compounds, thiophene compounds, phthalocyanine compounds, cyanine compounds, merocyanine compounds, oxonol compounds, polyamine compounds, indole compounds, pyrrole compounds, pyrazole compounds, polyarylene compounds, fused aromatic carbocyclic compounds (for example, naphthalene derivatives, anthracene derivatives, phenanthrene derivatives, tetracene derivatives, pyrene derivatives, perylene derivatives, and fluoranthene derivatives), and metal complexes having, as a ligand, a nitrogen-containing heterocyclic compound. Incidentally, the invention is not limited to these compounds, and as described previously, an organic compound having a smaller ionization potential than that of an organic compound to be used as an n-type compound (having acceptor properties) may be used as the organic semiconductor having donor properties.

The organic n-type semiconductor (compound) is an organic semiconductor (compound) having acceptor properties and refers to an organic compound which is mainly represented by an electron transporting organic compound and which has properties such that it is liable to accept an electron. In more detail, the organic n-type semiconductor refers to an organic compound having a larger electron affinity in two organic compounds when they are brought into contact with each other and used. Accordingly, with respect to the organic compound having acceptor properties, any organic compound can be used so far as it is an electron accepting organic compound. Useful examples thereof include fused aromatic carbocyclic compounds (for example, naphthalene derivatives, anthracene derivatives, phenanthroline derivatives, tetracene derivatives, pyrene derivatives, perylene derivatives, and fluoranthene derivatives), 5- to 7-membered heterocyclic compounds containing a nitrogen atom, an oxygen atom or a sulfur atom (for example, pyridine, pyrazine, pyrimidine, pyridazine, triazine, quinoline, quinoxaline, quinazoline, phthalazine, cinnoline, isoquinoline, pteridine, acridine, phenazine, phenanthroline, tetrazole, pyrazole, imidazole, thiazole, oxazole, indazole, benzimidazole, benzotriazole, benzoxazole, benzothiazole, carbazole, purine, triazolopyridazine, triazolopyrimidine, tetrazaindene, oxadiazole, imidazopyridine, pyralidine, pyrrolopyridine, thiadiazolopyridine, dibenzazepine, and tribenzazepine), polyarylene compounds, fluorene compounds, cyclopentadiene compounds, silyl compounds, and metal complexes having, as a ligand, a nitrogen-containing heterocyclic compound. Incidentally, the invention is not limited to these compounds, and as described previously, an organic compound having a larger electron affinity than that of an organic compound to be used as an organic compound having donor properties may be used as the organic semiconductor having acceptor properties.

Though any organic dye is useful as the p-type organic dye or n-type organic dye, preferred examples thereof include cyanine dyes, styryl dyes, hemicyanine dyes, merocyanine dyes (inclusive of zeromethinemerocyanine (simple merocyanine)), trinuclear merocyanine dyes, tetranuclear merocyanine dyes, rhodacyanine dyes, complex cyanine dyes, complex merocyanine dyes, alopolar dyes, oxonol dyes, hemioxonol dyes, squarylium dyes, croconium dyes, azamethine dyes, coumarin dyes, arylidene dyes, anthraquinone dyes, triphenylmethane dyes, azo dyes, azomethine dyes, spiro compounds, metallocene dyes, fluorenone dyes, flugide dyes, perylene dyes, phenazine dyes, phenothiazine dyes, quinone dyes, indigo dyes, diphenylmethane dyes, polyene dyes, acridine dyes, acridinone dyes, diphenylamine dyes, quinacridone dyes, quinophthalone dyes, phenoxazine dyes, phthaloperylene dyes, porphyrin dyes, chlorophyll dyes, phthalocyanine dyes, metal complex dyes, and fused aromatic carbocyclic compounds (for example, naphthalene derivatives, anthracene derivatives, phenanthrene derivatives, tetracene derivatives, pyrene derivatives, perylene derivatives, and fluoranthene derivatives).

Next, the metal complex compound is described. The metal complex compound is a metal complex having a ligand containing at least one of a nitrogen atom, an oxygen atom and a sulfur atom coordinated to a metal. Though a metal ion in the metal complex is not particularly limited, it is preferably a beryllium ion, a magnesium ion, an aluminum ion, a gallium ion, a zinc ion, an indium ion, or a tin ion; more preferably a beryllium ion, an aluminum ion, a gallium ion, or a zinc ion; and further preferably an aluminum ion or a zinc ion. As the ligand which is contained in the metal complex, there are enumerated various known ligands. Examples thereof include ligands as described in H. Yersin, Photochemistry and Photophysics of Coordination Compounds, Springer-Verlag, 1987; and Akio Yamamoto, Organometallic Chemistry—Principles and Applications, Shokabo Publishing Co., Ltd., 1982.

The foregoing ligand is preferably a nitrogen-containing heterocyclic ligand (having preferably from 1 to 30 carbon atoms, more preferably from 2 to 20 carbon atoms, and especially preferably from 3 to 15 carbon atoms, which may be a monodentate ligand or a bidentate or polydentate ligand, with a bidentate ligand being preferable; and examples of which include a pyridine ligand, a bipyridyl ligand, a quinolinol ligand, and a hydroxyphenylazole ligand (for example, a hydroxyphenylbenzimidazole ligand, a hydroxyphenylbenzoxazole ligand, and a hydroxyphenylimidazole ligand)), an alkoxy ligand (having preferably from 1 to 30 carbon atoms, more preferably from 1 to 20 carbon atoms, and especially preferably from 1 to 10 carbon atoms, examples of which include methoxy, ethoxy, butoxy, and 2-ethylhexyloxy) an aryloxy ligand (having preferably from 6 to 30 carbon atoms, more preferably from 6 to 20 carbon atoms, and especially preferably from 6 to 12 carbon atoms, examples of which include phenyloxy, 1-naphthyloxy, 2-naphthyloxy, 2,4,6-trimethylphenyloxy, and 4-biphenyloxy), a heteroaryloxy ligand (having preferably from 1 to 30 carbon atoms, more preferably from 1 to 20 carbon atoms, and especially preferably from 1 to 12 carbon atoms, examples of which include pyridyloxy, pyrazyloxy, pyrimidyloxy, and quinolyloxy), an alkylthio ligand (having preferably from 1 to 30 carbon atoms, more preferably from 1 to 20 carbon atoms, and especially preferably from 1 to 12 carbon atoms, examples of which include methylthio and ethylthio), an arylthio ligand (having preferably from 6 to 30 carbon atoms, more preferably from 6 to 20 carbon atoms, and especially preferably from 6 to 12 carbon atoms, examples of which include phenylthio) a heterocyclic substituted thio ligand (having preferably from 1 to 30 carbon atoms, more preferably from 1 to 20 carbon atoms, and especially preferably from 1 to 12 carbon atoms, examples of which include pyridylthio, 2-benzimidazolylthio, 2-benzoxazolylthio, and 2-benzothiazolylthio), or a siloxy ligand (having preferably from 1 to 30 carbon atoms, more preferably from 3 to 25 carbon atoms, and especially preferably from 6 to 20 carbon atoms, examples of which include a triphenyloxy group, a triethoxysiloxy group, and a triisopropylsiloxy group); more preferably a nitrogen-containing heterocyclic ligand, an aryloxy ligand, a heteroaryloxy ligand, or a siloxy ligand; and further preferably a nitrogen-containing heterocyclic ligand, an aryloxy ligand, or a siloxy ligand.

The case where the organic photoelectric conversion device of the present embodiment contains a photoelectric conversion layer having a p-type semiconductor layer and an n-type semiconductor layer between a pair of electrodes, with at least one of the p-type semiconductor and the n-type semiconductor being an organic semiconductor and having a bulk heterojunction structure layer containing the p-type semiconductor and the n-type semiconductor as an interlayer between these semiconductor layers is preferable. In such case, in the photoelectric conversion layer, by containing a bulk heterojunction structure in the organic layer, it is possible to compensate a drawback that the organic layer has a short carrier diffusion length and to improve the photoelectric conversion efficiency. Incidentally, the bulk heterojunction structure is described in detail in Japanese Patent Application No. 2004-080639 (corresponding to JP-A-2005-303266).

The case where the photoelectric conversion device of the present embodiment contains a photoelectric conversion layer having a structure having two or more of a repeating structure (tandem structure) of a pn junction layer formed of the p-type semiconductor layer and the n-type semiconductor layer between a pair of electrodes is preferable; and the case where a thin layer made of a conducting material is inserted between the foregoing repeating structures is more preferable. The number of the repeating structure (tandem structure) of a pn junction layer is not limited. For the purpose of enhancing the photoelectric conversion efficiency, the number of the repeating structure of a pn junction layer is preferably from 2 to 50, more preferably from 2 to 30, and especially preferably from 2 to 10. The conducting material is preferably silver or gold, and most preferably silver. Incidentally, the tandem structure is described in detail in Japanese Patent Application No. 2004-079930 (corresponding to JP-A-2005-303266).

In the photoelectric conversion device having a layer of a p-type semiconductor and a layer of an n-type semiconductor (preferably a mixed or dispersed (bulk heterojunction structure) layer) between a pair of electrodes, the case where an orientation-controlled organic compound is contained in at least one of the p-type semiconductor and the n-type semiconductor is preferable; and the case where an orientation-controlled (or orientation controllable) organic compound is contained in both the p-type semiconductor and the n-type semiconductor is more preferable. As this organic compound, an organic compound having a π-conjugated electron is preferably used. It is preferable that this n-electron plane is not vertical to a substrate (electrode substrate) but is oriented at an angle close to parallel to the substrate as far as possible. The angle against the substrate is preferably 0° or more and not more than 80°, more preferably 0° or more and not more than 60°, further preferably 0° or more and not more than 40°, still further preferably 0° or more and not more than 20°, especially preferably 0° or more and not more than 10°, and most preferably 0° (namely, in parallel to the substrate). As described previously, it is merely required that the layer of the orientation-controlled organic compound is contained in even a part of the organic layer against the whole thereof. A proportion of the orientation-controlled portion to the whole of the organic layer is preferably 10% or more, more preferably 30% or more, further preferably 50% or more, still further preferably 70% or more, especially preferably 90% or more, and most preferably 100%. By controlling the orientation of the organic compound in the organic layer, the foregoing state compensates a drawback that the organic layer has a short carrier diffusion length, thereby improving the photoelectric conversion efficiency.

In the case where the orientation of an organic compound is controlled, the case where the heterojunction plane (for example, a pn junction plane) is not in parallel to a substrate is more preferable. It is preferable that the heterojunction plane is not in parallel to the substrate (electrode substrate) but is oriented at an angle close to verticality to the substrate as far as possible. The angle to the substrate is preferably 10° or more and not more than 90°, more preferably 30° or more and not more than 90°, further preferably 50° or more and not more than 90°, still further preferably 70° or more and not more than 90°, especially preferably 80° or more and not more than 90°, and most preferably 90° (namely, vertical to the substrate). As described previously, it is merely required that the heterojunction plane-controlled organic compound is contained in even a part of the organic layer against the whole thereof. A proportion of the orientation-controlled portion to the whole of the organic layer is preferably 10% or more, more preferably 30% or more, further preferably 50% or more, still further preferably 70% or more, especially preferably 90% or more, and most preferably 100%. In such case, the area of the heterojunction plane in the organic layer increases and the amount of a carrier such as an electron, a hole and a pair of an electron and a hole as formed on the interface increases so that it becomes possible to improve the photoelectric conversion efficiency. In the light of the above, in the photoelectric conversion layer in which the orientation of the organic compound on both the heterojunction plane and the π-electron plane is controlled, it is possible to improve especially the photoelectric conversion efficiency. These states are described in detail in Japanese Patent Application No. 2004-079931 (corresponding to JP-A-2006-86493). From the standpoint of optical absorption, it is preferable that the thickness of the organic dye layer is thick as far as possible. However, taking into consideration a proportion which does not contribute to the charge separation, the thickness of the organic dye layer in the invention is preferably 30 nm or more and not more than 300 nm, more preferably 50 nm or more and not more than 250 nm, and especially preferably 80 nm or more and not more than 200 nm.

### (Formation Method of Organic Layer)

The organic layer is fabricated by a dry fabrication method or a wet fabrication method. Specific examples of the dry fabrication method include physical vapor phase epitaxy methods such as a vacuum vapor deposition method, a sputtering method, an ion plating method, and an MBE method; and CVD methods such as plasma polymerization. Examples of the wet fabrication method include a casting method, a spin coating method, a dipping method, and an LB method. In the case of using a high molecular weight compound in at least one of the p-type semiconductor (compound) and the n-type semiconductor (compound), it is preferable that the fabrication is achieved by a wet fabrication method which is easy for the preparation. In the case of employing a dry fabrication method such as vapor deposition, the use of a high molecular weight compound is difficult because of possible occurrence of decomposition. Accordingly, its oligomer can be preferably used as a replacement thereof. On the other hand, in the present embodiment, in the case of using a low molecular weight compound, a dry fabrication method is preferably employed, and a vacuum vapor deposition method is especially preferably employed. In the vacuum vapor deposition method, a method for heating a compound such as a resistance heating vapor deposition method and an electron beam heating vapor deposition method, the shape of a vapor deposition source such as a crucible and a boat, a degree of vacuum, a vapor deposition temperature, a substrate temperature, a vapor deposition rate, and the like are a basic parameter. In order to make it possible to achieve uniform vapor deposition, it is preferable that the vapor deposition is carried out while rotating the substrate. A high degree of vacuum is preferable. The vacuum vapor deposition is carried out at a degree of vacuum of not more than 10⁻⁴ Torr, preferably not more than 10⁻⁶ Torr, and especially preferably not more than 10⁻⁸ Torr. It is preferable that all steps at the vapor deposition are carried out in vacuo. Basically, the vacuum vapor fabrication is carried out in such a manner that the compound does not come into direct contact with the external oxygen and moisture. The foregoing conditions of the vacuum vapor deposition must be strictly controlled because they affect crystallinity, amorphous properties, density, compactness, and so on. It is preferably employed to subject the vapor deposition rate to PI or PID control using a layer thickness monitor such as a quartz oscillator and an interferometer. In the case of vapor depositing two or more kinds of compounds at the same time, a dual-source vapor deposition method, a flash vapor deposition method and so on can be preferably employed.

### (Electrode)

It is preferable that a counter electrode extracts a hole from a hole transporting photoelectric conversion layer or a hole transport layer, and a material such as metals, alloys, metal oxides, electrically conducting compounds, and mixtures thereof can be used. It is preferable that a pixel electrode extracts an electron from an electron transporting photoelectric conversion layer or an electron transport layer, and a material is selected while taking into consideration adhesion with an adjacent layer such as the electron transporting photoelectric conversion layer and an electron transport layer, electron affinity, ionization potential, stability, and the like. Specific examples of such a material include conducting metal oxides (for example, tin oxide, zinc oxide, indium oxide, and indium tin oxide (ITO)); metals (for example, gold, silver, chromium, and nickel); mixtures or stacks of such a metal and such a conducting metal oxide; inorganic conducting substances (for example, copper iodide and copper sulfide); organic conducting materials (for example, polyaniline, polythiophene, and polypyrrole); silicon compounds; and stack materials thereof with ITO. Of these, conducting metal oxides are preferable; and ITO and IZO are especially preferable in view of productivity, high conductivity, transparency, and so on. Though the layer thickness can be properly selected depending upon the material, in general, it is preferably in the range of 10 nm or more and not more than 1 μm, more preferably 30 nm or more and not more than 500 nm, and further preferably 50 nm or more and not more than 300 nm.

In the preparation of the pixel electrode and the counter electrode, various methods are employable depending upon the material. For example, in the case of ITO, the layer is formed by a method such as an electron beam method, a sputtering method, a resistance heating vapor deposition method, a chemical reaction method (for example, a sol-gel method), and coating of an indium tin oxide dispersion. In the case of ITO, a UV-ozone treatment, a plasma treatment, or the like can be applied. In the present embodiment, it is preferable that the transparent electrode is prepared in a plasma-free state. By preparing the transparent electrode in a plasma-free state, it is possible to minimize influences of the plasma against the substrate and to make photoelectric conversion characteristics satisfactory. Here, the term “plasma-free state” means a state that plasma is not generated during the fabrication of the transparent electrode or that a distance from the plasma generation source to the substrate is 2 cm or more, preferably 10 cm or more, and more preferably 20 cm or more and that the plasma which reaches the substrate is reduced.

Examples of an apparatus in which plasma is not generated during the fabrication of the transparent electrode include an electron beam vapor deposition apparatus (EB vapor deposition apparatus) and a pulse laser vapor deposition apparatus. With respect to the EB vapor deposition apparatus or pulse laser vapor deposition apparatus, apparatus as described in Developments of Transparent Conducting Films, supervised by Yutaka Sawada (published by CMC Publishing Co., Ltd., 1999); Developments of Transparent Conducting Films II, supervised by Yutaka Sawada (published by CMC Publishing Co., Ltd., 2002); Technologies of Transparent Conducting Films, written by Japan Society for the Promotion of Science (published by Ohmsha, Ltd., 1999); and references as added therein can be used. In the following, the method for achieving fabrication of a transparent electrode using an EB vapor deposition apparatus is referred to as “EB vapor deposition method”; and the method for achieving fabrication of a transparent electrode using a pulse laser vapor deposition apparatus is referred to as “pulse laser vapor deposition method”.

With respect to the apparatus capable of realizing the state that a distance from the plasma generation source to the substrate is 2 cm or more and that the plasma which reaches the substrate is reduced (hereinafter referred to as “plasma-free fabrication apparatus”), for example, a counter target type sputtering apparatus and an arc plasma vapor deposition method can be thought. With respect to these matters, apparatus as described in Developments of Transparent Conducting Films, supervised by Yutaka Sawada (published by CMC Publishing Co., Ltd., 1999); Developments of Transparent Conducting Films II, supervised by Yutaka Sawada (published by CMC Publishing Co., Ltd., 2002); Technologies of Transparent Conducting Films, written by Japan Society for the Promotion of Science (published by Ohmsha, Ltd., 1999); and references as added therein can be used.

As configuration examples of the organic photoelectric conversion device stack, first of all, in the case where a single organic layer is stacked on a substrate, there is enumerated a configuration in which a pixel electrode (basically a transparent electrode), a photoelectric conversion layer and a counter electrode (transparent electrode) are stacked in this order from the substrate. However, it should not be construed that the invention is limited thereto. Furthermore, in the case where two organic layers are stacked on a substrate, there is enumerated a configuration in which a pixel electrode (basically a transparent electrode), a photoelectric conversion layer, a counter electrode (transparent electrode), an interlaminar insulating layer, a pixel electrode (basically a transparent electrode), a photoelectric conversion layer, and a counter electrode (transparent electrode) are stacked in this order from the substrate.

As the material of the transparent electrode of the present embodiment, materials which can be fabricated by a plasma-free fabrication apparatus, an EB vapor deposition apparatus or a pulse laser vapor deposition apparatus are preferable. For example, metals, alloys, metal oxides, metal nitrides, metallic borides, organic conducting compounds, and mixtures thereof can be suitably enumerated. Specific examples thereof include conducting metal oxides such as tin oxide, zinc oxide, indium oxide, indium zinc oxide (IZO), indium tin oxide (ITO), and indium tungsten oxide (IWO); metal nitrides such as titanium nitride; metals such as gold, platinum, silver, chromium, nickel, and aluminum; mixtures or stacks of such a metal and such a conducting metal oxide; inorganic conducting substances such as copper iodide and copper sulfide; organic conducting materials such as polyaniline, polythiophene, and polypyrrole; and stacks thereof with ITO. Also, materials as described in detail in Developments of Transparent Conducting Films, supervised by Yutaka Sawada (published by CMC Publishing Co., Ltd., 1999); Developments of Transparent Conducting Films II, supervised by Yutaka Sawada (published by CMC Publishing Co., Ltd., 2002); Technologies of Transparent Conducting Films, written by Japan Society for the Promotion of Science (published by Ohmsha, Ltd., 1999); and references as added therein may be used.

As the material of the transparent electrode layer, any one of materials of ITO, IZO, SnO₂, ATO (antimony-doped tin oxide), ZnO, AZO (Al-doped zinc oxide), GZO (gallium-doped zinc oxide), TiO₂, and FTO (fluorine-doped tin oxide) is especially preferable. A light transmittance of the transparent electrode layer is preferably 60% or more, more preferably 80% or more, further preferably 90% or more, and still further preferably 95% or more at a photoelectric conversion light absorption peak wavelength of the photoelectric conversion layer to be contained in a photoelectric conversion device containing the subject transparent electrode layer. Also, with respect to a surface resistance of the transparent electrode layer, its preferred range varies depending upon whether the transparent electrode layer is a pixel electrode or a counter electrode and whether the charge storage/transfer/readout site is of a CCD structure or a CMOS structure, and the like. In the case where the transparent electrode layer is used for a counter electrode and the charge storage/transfer/readout site is of a CMOS structure, the surface resistance is preferably not more than 10,000 Ω/, and more preferably not more than 1,000 Ω/. In the case where the transparent electrode layer is used for a counter electrode and the charge storage/transfer/readout site is of a CCD structure, the surface resistance is preferably not more than 1,000 Ω/, and more preferably not more than 100 Ω/. In the case where the transparent electrode layer is used for a pixel electrode, the surface resistance is preferably not more than 1,000,000 Ω/, and more preferably not more than 100,000 Ω/.

Conditions at the fabrication of a transparent electrode are hereunder mentioned. A substrate temperature at the fabrication of a transparent electrode is preferably not higher than 500° C., more preferably not higher than 300° C., further preferably not higher than 200° C., and still further preferably not higher than 150° C. Furthermore, a gas may be introduced during the fabrication of a transparent electrode. Basically, though the gas species is not limited, Ar, He, oxygen, nitrogen, and so on can be used. Furthermore, a mixed gas of such gases may be used. In particular, in the case of an oxide material, since oxygen deficiency often occurs, it is preferred to use oxygen.

In view of the point that the photoelectric conversion efficiency is improved, the case of applying a voltage to a pair of electrodes configuring the organic photoelectric conversion device of the present embodiment is preferable. Though any voltage is employable as the voltage to be applied, a necessary voltage varies with the layer thickness of the photoelectric conversion layer. That is, the larger an electric field to be added in the photoelectric conversion layer, the more improved the photoelectric conversion efficiency is. However, even when the same voltage is applied, the thinner the layer thickness of the photoelectric conversion layer, the larger an electric field to be applied is. Accordingly, in the case where the layer thickness of the photoelectric conversion layer is thin, the voltage to be applied may be relatively small. The electric field to be applied to the photoelectric conversion layer is preferably 10 V/m or more, more preferably 1×10³V/m or more, further preferably 1×10⁵ V/m or more, especially preferably 1×10⁶ V/m or more, and most preferably 1×10⁷ V/m or more. Though there is no particular upper limit, when the electric field is excessively applied, an electric current flows even in a dark place and therefore, such is not preferable. The electric field is preferably not more than 1×10¹² V/m, and more preferably not more than 1×10⁹ V/m.

### (Inorganic Photoelectric Conversion Part (Inorganic Layer))

As the inorganic photoelectric conversion device, pn junction or pin junction of crystalline silicon, amorphous silicon or a chemical semiconductor such as GaAs is generally employed. With respect to the stack type structure, a method disclosed in U.S. Pat. No. 5,965,875 can be employed. That is, a configuration in which a light receiving part stacked by utilizing wavelength dependency of an absorption factor of silicon is formed and color separation is carried out in a depth direction thereof is employable. In that case, since the color separation is carried out with a light penetration depth of silicon, a spectrum range which is detected in each of the stacked light receiving parts becomes broad. However, by using the foregoing organic layer as the upper layer, namely by detecting the light which has transmitted through the organic layer in the depth direction of silicon, the color separation is remarkably improved. In particular, when a G layer is disposed in the organic layer, since light which has transmitted through the organic layer is B light and R light, only the BR light is a subject to the separation of light in the depth direction in silicon so that the color separation is improved. Even in the case where the organic layer is a B layer or an R layer, by properly selecting the electromagnetic absorption/photoelectric conversion site of silicon in the depth direction, the color separation is remarkably improved. In the case where the organic layer is made of two layers, the function as the electromagnetic absorption/photoelectric conversion site of silicon may be brought for only a single color, and preferred color separation can be achieved.

The inorganic layer preferably has a structure in which plural photodiodes are superimposed for every pixel in a depth direction within the semiconductor substrate and a color signal corresponding to a signal charge generated in each of the photodiodes by light absorbed in the plural photodiodes is read out externally. It is preferable that the plural photodiodes contain a first photodiode provided in the depth for absorbing B light and at least one second photodiode provided in the depth for absorbing R light and are provided with a color signal readout circuit for reading out a color signal corresponding to the foregoing signal charge generated in each of the foregoing plural photodiodes. According to this configuration, it is possible to carry out color separation without using a color filter. Also, according to circumstances, since light of a component negative sensitivity can also be received, it becomes possible to realize color imaging with good color reproducibility. Also, in the invention, it is preferable that a junction part of the foregoing first photodiode is formed in a depth of up to about 0.2 μm from the semiconductor substrate surface and that a junction part of the foregoing second photodiode is formed in a depth of up to about 2 μm from the semiconductor substrate surface.

The inorganic layer is hereunder described in more detail. Preferred examples of the configuration of the inorganic layer include light receiving devices of a photoconducting type, a p-n junction type, a shotkey junction type, a PIN junction type, or an MSM (metal-semiconductor-metal) type; and light receiving devices of a phototransistor type. In the present embodiment, in the case where plural photodiodes are stacked, it is preferred to apply a configuration in which a plurality of a first conducting type region and a second conducting type region which is a reversed conducting type to the first conducting type are alternately stacked within a single semiconductor substrate and each of the junction planes of the first conducting type region and the second conducting type region is formed in a depth suitable for photoelectrically converting mainly plural lights of a different wavelength region. The single semiconductor substrate is preferably mono-crystalline silicon, and the color separation can be carried out by utilizing absorption wavelength characteristics relying upon the depth direction of the silicon substrate.

As the inorganic semiconductor, InGaN based, InAlN based, InAlP based, or InGaAlP based inorganic semiconductors can also be used. The InGaN based inorganic semiconductor is an inorganic semiconductor adjusted so as to have a maximum absorption value within a blue wavelength range by properly changing the In-containing composition. That is, the composition becomes InₓGa₁₋ₓN (0≦x<1). Such a compound semiconductor is manufactured by employing a metal organic chemical vapor deposition method (MOCVD method). With respect to the InAlN based nitride semiconductor using, as a raw material, Al of the group 13 similar to Ga, it can be used as a short wavelength light receiving part similar to the InGaN based semiconductor. Also, InAlP or InGaAlP lattice-matching with a GaAs substrate can also be used.

The inorganic semiconductor may be of a buried structure. The “buried structure” as referred to herein refers to a configuration in which the both ends of a short wavelength light receiving part are covered by a semiconductor which is different from the short wavelength light receiving part. The semiconductor for covering the both ends is preferably a semiconductor having a band gap wavelength shorter than or equal to a hand gap wavelength of the short wavelength light receiving part. In such a photodiode, when an n-type layer, a p-type layer, an n-type layer and a p-type layer which are successively diffused from the p-type silicon substrate surface are deeply formed in this order, the pn-junction diode is formed of four layers of pnpn in a depth direction of silicon. With respect to the light which has been made incident on the diode from the surface side, the longer the wavelength, the deeper the light penetration is. Also, with respect to the incident wavelength and the attenuation coefficient, values which are inherent to silicon are exhibited. Accordingly, the photodiode is designed such that the depth of the pn junction plane covers respective wavelength bands of visible light. Similarly, a junction diode of three layers of npn is obtained by forming an n-type layer, a p-type layer and n-type layer in this order. Here, a light signal is extracted from the n-type layer, and the p-type layer is grounded. Also, when an extraction electrode is provided in each region and a prescribed reset potential is applied, each region is depleted, and the capacity of each junction part becomes small unlimitedly. In this way, it is possible to make the capacity generated on the junction plane extremely small.

### (Signal Readout Part)

As to the signal readout part, JP-A-58-103166, JP-A-58-103165, JP-A-2003-332551, and so on can be made hereof by reference. A configuration in which an MOS transistor is formed on a semiconductor substrate or a configuration having CCD as a device can be properly employed. For example, in the case of a photoelectric conversion device using an MOS transistor, a charge is generated in a photoelectric conversion layer by incident light which has transmitted through the electrodes; the charge runs to the electrodes within the photoelectric conversion layer by an electric field generated between the electrodes by applying a voltage to the electrodes; and the charge is further transferred to a charge storage part of the MOS transistor and stored in the charge storage part. The charge stored in the charge storage part is transferred to a charge readout part by switching of the MOS transistor and further outputted as an electric signal. In this way, full-color image signals are inputted in a solid-state imaging apparatus including a signal processing part.

The signal charge can be read out by injecting a fixed amount of a bias charge into the storage diode (refresh mode) and then storing a fixed amount of the charge (photoelectric conversion mode). The light receiving device itself can be used as the storage diode, or a storage diode can be separately provided.

The readout of a signal is hereunder described in more detail. The readout of a signal can be carried out by using a usual color readout circuit. A signal charge or a signal current which has been subjected to light/electric conversion in the light receiving part is stored in the light receiving part itself or a capacitor as provided therein. The stored charge is subjected to selection of a pixel position and readout by a measure of an MOS type imaging device (so-called CMOS sensor) using an X-Y address system. Besides, as an address selection system, there is enumerated a system in which every pixel is successively selected by a multiplexer switch and a digital shift register and read out as a signal voltage (or a charge) on a common output line. An imaging device of a two-dimensionally arrayed X-Y address operation is known as a CMOS sensor. In this imaging device, a switch provided in a pixel connected to an X-Y intersection point is connected to a vertical shift register, and when the switch is turned on by a voltage from the vertical scanning shift register, signals read out from pixels as provided on the same line is read out on the output line in a column direction. The signals are successively read out from an output end through the switch to be driven by a horizontal scanning shift register.

For reading out the output signals, a floating diffusion detector or a floating gate detector can be used. Also, it is possible to seek improvements of S/N by a measure such as provision of a signal amplification circuit in the pixel portion and correlated double sampling.

For the signal processing, gamma correction by an ADC circuit, digitalization by an AD transducer, luminance signal processing, and color signal processing can be applied. Examples of the color signal processing include white balance processing, color separation processing, and color matrix processing. In the use for an NTSC signal, an RGB signal can be subjected to conversion processing of a YIQ signal.

The signal readout part must have a mobility of charge of 100 cm²/V/sec or more. This mobility can be obtained by selecting the material among semiconductors of the IV group, the III-V group or the II-VI group. Above all, silicon semiconductors are preferable because of advancement of microstructure refinement technology and low costs. As to the signal readout system, there are made a number of proposals, and all of them are employable. Above all, a COMS type device or a CCD type device is an especially preferred system. Furthermore, in the case of the present embodiment, in many occasions, the CMOS type device is preferable in view of high-speed readout, pixel addition, partial readout, consumed electricity, and the like.

### (Connection)

Though the contact site in which the pixel electrode and the storage diode are connected to each other may be connected by using any metal, a metal selected among copper, aluminum, silver, gold, chromium and tungsten is preferable, with copper being especially preferable. In the case where plural organic photoelectric conversion devices are stacked, it is necessary that the storage diode is provided for every organic photoelectric conversion device and that the pixel electrode and the storage diode of each of the organic photoelectric conversion devices are connected to each other in the contact site.

### (Process)

The device for DNA analysis of the present embodiment can be manufactured according to a so-called known microfabrication process which is employed in manufacturing integrated circuits and the like. Basically, this process is concerned with a repeated operation of pattern exposure with active light, electron beams, etc. (for example, i- or g-bright line of mercury, excimer laser, X-rays, and electron beams), pattern formation by development and/or burning, alignment of device forming materials (for example, coating, vapor deposition, sputtering, and CV), and removal of the materials in a non-pattern area (for example, heat treatment and dissolution treatment).

This application is based on Japanese Patent application JP 2006-175701, filed Jun. 26, 2006, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. A device for DNA analysis comprising:
an imaging device having a plurality of pixel parts; and
microarrays arranged and fixed on a surface on a side of light incidence of the imaging device, wherein
each of the plurality of pixel parts includes plural kinds of photoelectric conversion parts stacked on a semiconductor substrate and each capable of detecting light with a different wavelength region from each other to generate a charge corresponding thereto;
the plural kinds of photoelectric conversion parts are stacked such that they are able to receive light from the same subject; and
the plural kinds of photoelectric conversion parts are each configured of at least one photoelectric conversion device having sensitivity to the light to be detected in the photoelectric conversion part and arranged on a same plane.

2. The device according to claim 1, wherein each of a plurality of DNA fragments configuring the microarrays and each of the plurality of pixel parts are corresponding one-to-one with each other.

3. The device according to claim 1, wherein the plural kinds of photoelectric conversion parts are each configured of a single photoelectric conversion device.

4. The device according to claim 1, wherein the plural kinds of photoelectric conversion parts included in the pixel part include at least one organic photoelectric conversion part which is configured of an organic photoelectric conversion device including a pair of electrodes and an organic photoelectric conversion layer interposed between the pair of electrodes and at least one inorganic photoelectric conversion part which is configured of an inorganic photoelectric conversion device provided within the semiconductor substrate.

5. The device according to claim 4, wherein the imaging device is provided with a passivation layer for passivating the organic photoelectric conversion device which is formed in an upper part of the organic photoelectric conversion device by an ALCVD method.

6. The device according to claim 5, wherein the passivation layer comprises an inorganic material.

7. The device according to claim 5, wherein the passivation layer is of a structure including an inorganic layer comprising an inorganic material and an organic layer comprising an organic polymer.

8. The device according to claim 4, wherein the plural kinds of photoelectric conversion parts are two of the organic photoelectric conversion part and the inorganic photoelectric conversion part.

9. The device according to claim 8, wherein
the organic photoelectric conversion device has sensitivity to light of a red or green wavelength region; and
the inorganic photoelectric conversion device has sensitivity to light of a green or red wavelength region.

10. The device according to claim 9, wherein
the organic photoelectric conversion device has sensitivity to light of a green wavelength region; and
the inorganic photoelectric conversion device has sensitivity to light of a red wavelength region.

11. The device according to claim 1, wherein
at the DNA analysis, each of the plurality of DNA fragments configuring the microarrays is bound with plural sample DNAs labeled by each of plural kinds of fluorescent substances each of which is excited by excitation light to emit fluorescence of a wavelength region detectable by each of the plural kinds of photoelectric conversion parts; and
an excitation light incidence preventing unit for preventing the excitation light for exciting each of the plural kinds of fluorescent substances from incidence into the photoelectric conversion part which is able to detect the fluorescence emitted from the fluorescent substance is provided.

12. The device according to claim 8, wherein
at the DNA analysis, each of the plurality of DNA fragments configuring the microarrays is bound with two sample DNAs labeled by each of two fluorescent substances each of which is excited by excitation light to emit fluorescence of a wavelength region detectable by each of the organic photoelectric conversion part and the inorganic photoelectric conversion part; and
an excitation light incidence preventing unit for preventing the excitation light for exciting each of the two fluorescent substances from incidence into the photoelectric conversion part which is able to detect the fluorescence emitted from the fluorescent substance is provided.

13. The device according to claim 12, wherein
the excitation light incidence preventing unit comprises a first excitation light cut-off filter and a second excitation light cut-off filter;
the first excitation light cut-off filter is provided between the inorganic photoelectric conversion part and the organic photoelectric conversion part and prevents transmission of the excitation light for exciting the fluorescent substance which emits fluorescence of a wavelength region detectable by the inorganic photoelectric conversion part; and
the second excitation light cut-off filter is provided in an upper part of the organic photoelectric conversion part and prevents transmission of the excitation light for exciting the fluorescent substance which emits fluorescence of a wavelength region detectable by the organic photoelectric conversion part.

14. The device according to claim 1, wherein a signal readout part for reading out a signal corresponding to the charge generated in each of the plural kinds of photoelectric conversion parts by CCD or a CMOS circuit is provided.

15. The device according to claim 14, wherein
the signal readout part reads out the signal by a CMOS circuit; and
a part of the CMOS circuit is made common in the plural kinds of photoelectric conversion parts.

16. The device according to claim 1, wherein the microarrays are a microarray for performing DNA analysis by hybridization.

17. A DNA analysis apparatus comprising:
the device according to claim 1; and
a light outputting unit for outputting light obliquely against the surface of the imaging device having the microarrays formed therein.
